(19) United States
(12) Patent Application Publication
(10) Pub. No.: US 2016/0376052 A1
(43) Pub. Date: Dec. 29, 2016

(54) BOTTLE HAVING ONE OR MORE INTERNAL PROJECTIONS

(71) Applicant: Owens-Brockway Glass Container Inc., Perrysburg, OH (US)

(72) Inventors: Douglas Laib, Perrysburg, OH (US); Raul M. Paredes, Perrysburg, OH (US); Megan Herman, Toledo, OH (US); Karl A. Reisig, Maumee, OH (US); Brian J. Chisholm, Sylvania, OH (US); Jessica R. Bryant, Toledo, OH (US)

(21) Appl. No.: 15/257,149

(22) Filed: Sep. 6, 2016

Related U.S. Application Data
(62) Division of application No. 14/297,791, filed on Jun. 6, 2014.
Application No. 14/297,791 is a continuation-in-part of application No. 13/709,288, filed on Dec. 10, 2012.

(51) Int. Cl. B65D 1/02; C03B 9/32; C03B 9/193; C03B 9/16

(52) U.S. Cl. CPC B65D 1/0246; C03B 9/165; C03B 9/32; C03B 9/1932

(57) ABSTRACT

A bottle comprising a neck that includes a longitudinal axis extending therethrough, a neck finish, and a radially-facing interior surface. The neck further includes one or more internal projections projecting in a radially-inwardly direction from the interior surface of the neck and axially overlapping at least a portion of the neck finish.

### BACKGROUND AND SUMMARY OF THE DISCLOSURE

Bottles typically include a base, a shoulder, a body extending between the base and the shoulder, and a neck extending from the shoulder and having a neck finish. Bottles of this type of construction may be used for packaging of liquid products including, for example without limitation, beer, soda, juice, wine, etc., among potentially other beverage and non-beverage products. Depending on the particular contents of the bottle (e.g., the particular beverage), the flavor of the contents may be enhanced by introducing a piece of fruit, for example, a slice or wedge of citrus (e.g., a lime, an orange, or another type of citrus), into the bottle. More specifically, a consumer may introduce a piece of fruit into the bottle through an opening or mouth of the neck finish.

A general object of the present disclosure, in accordance with one aspect of the disclosure, is to provide a bottle that maximizes the amount of juice that is squeezed from the fruit as it is introduced into the bottle and moves through the neck finish and neck of the bottle.

The present disclosure embodies a number of aspects that can be implemented separately from, or in combination with, each other.

A bottle, in accordance with one aspect of the disclosure, comprises a neck that includes a longitudinal axis extending therethrough, a neck finish, and a radially-facing interior surface. The neck further includes one or more internal proj ections proj ecting in a radially-inwardly direction from the interior surface and axially overlapping at least a portion of the neck finish.

In accordance with another aspect of the disclosure, there is provided a bottle comprising a neck that includes a longitudinal axis extending therethrough, a neck finish, an axially-facing sealing surface, and a radially-facing interior surface. The neck further includes a plurality of internal projections projecting in a radially-inwardly direction from the interior surface and axially overlapping at least a portion of the neck finish. At least one of the plurality of projections terminates at a point that is a predetermined distance below the sealing surface of the neck and that is axially-aligned with at least a portion of the neck finish.

In accordance with a further aspect of the disclosure, there is provided a bottle comprising a neck that includes a longitudinal axis extending therethrough, a neck finish, and a radially-facing interior surface. The neck further includes a plurality of internal projections projecting in a radially-inwardly direction from the interior surface and axially overlapping at least a portion of the neck finish. The neck still further includes a plurality of internal grooves extending in a radially-outwardly direction and axially along the interior surface of the neck and axially overlapping at least a portion of the neck finish. Each of the plurality of grooves is disposed adjacent to at least one of the plurality of projections.

### BRIEF DESCRIPTION OF THE DRAWINGS

The disclosure, together with additional objects, features, advantages and aspects thereof, will be best understood from the following description, the appended claims, and the accompanying drawings, in which:

FIG. 1 is a front elevational view of a bottle including a neck having a plurality of internal projections in accordance with an illustrative embodiment of the present disclosure;

FIG. 2 is an enlarged fragmentary perspective view of the bottle of FIG. 1;

FIG. 3A is an enlarged cross-sectional view of a portion of the neck of the bottle of FIG. 2, taken along line 3A thereof;

FIG. 3B is an enlarged cross-sectional view of another portion of the neck of the bottle of FIG. 1, taken along line 3B thereof;

FIG. 3C is a cross-sectional view of bottle including a neck having a plurality of internal projections in accordance with another illustrative embodiment of the present disclosure;

FIG. 3D is an enlarged fragmentary cross-sectional view of a portion of the bottle of FIG. 3C, taken along line 3D thereof;

FIG. 3E is a front elevational view of a bottle in accordance with another illustrative embodiment of the present disclosure;

FIG. 4 is a front elevational view of a press-and-blow plunger in accordance with an illustrative embodiment of the present disclosure;

FIG. 5 is a fragmentary cross-sectional elevational view of a bottle including a neck having a plurality of internal projections in accordance with another illustrative embodiment of the present disclosure;

FIG. 6 is a front elevational view of a blow-and-blow plunger in accordance with an illustrative embodiment of the present disclosure;

FIG. 7 is a fragmentary cross-sectional elevational view of a bottle including a neck having a plurality of internal projections in accordance with a further illustrative embodiment of the present disclosure;

FIG. 8A is a fragmentary perspective view of a bottle including a neck having a plurality of internal projections in accordance with yet another illustrative embodiment of the present disclosure;

FIG. 8B is a cross-sectional view of the bottle of FIG. 8A;

FIG. 9A is a fragmentary perspective view of a bottle including a neck having a plurality of internal projections in accordance with yet another illustrative embodiment of the present disclosure;

FIG. 9B is a cross-sectional view of the bottle of FIG. 9A;

FIG. 10A is a fragmentary perspective view of a bottle including a neck having a plurality of internal projections in accordance with yet another illustrative embodiment of the present disclosure;

FIG. 10B is a cross-sectional view of the bottle of FIG. 10A;

FIGS. 11 through 33 are cross-sectional views of bottles including necks having a plurality of internal projections in accordance with other illustrative embodiments of the present disclosure;

FIGS. 34A-34E are schematic views of a press-and-blow process and tooling according to an illustrative embodiment of the present disclosure;

FIGS. 35A-35E are schematic views of a blow-and-blow process and tooling according to an illustrative embodiment of the present disclosure;

FIG. 36 is a front elevational view of a wide-mouth bottle including a neck having a plurality of internal projections in accordance with an illustrative embodiment of the present disclosure;

FIG. 37 is a top plan view of the bottle illustrated in FIG. 36;

FIG. 38 is a perspective view of another example of a wide-mouth bottle including a neck having a plurality of internal projections in accordance with an illustrative embodiment of the present disclosure;

FIGS. 39-41 are cross-sectional views of alternate embodiments of the bottle illustrated in FIG. 38;

FIG. 42 is a front elevational view of still another example of a wide-mouth bottle including a neck having a plurality of internal projections and a pocket formed therein in accordance with an illustrative embodiment of the present disclosure;

FIG. 43 is an enlarged fragmentary front elevational view of the bottle of FIG. 42; and

FIG. 44 is an enlarged fragmentary perspective view of the bottle of FIG. 42.

### DETAILED DESCRIPTION

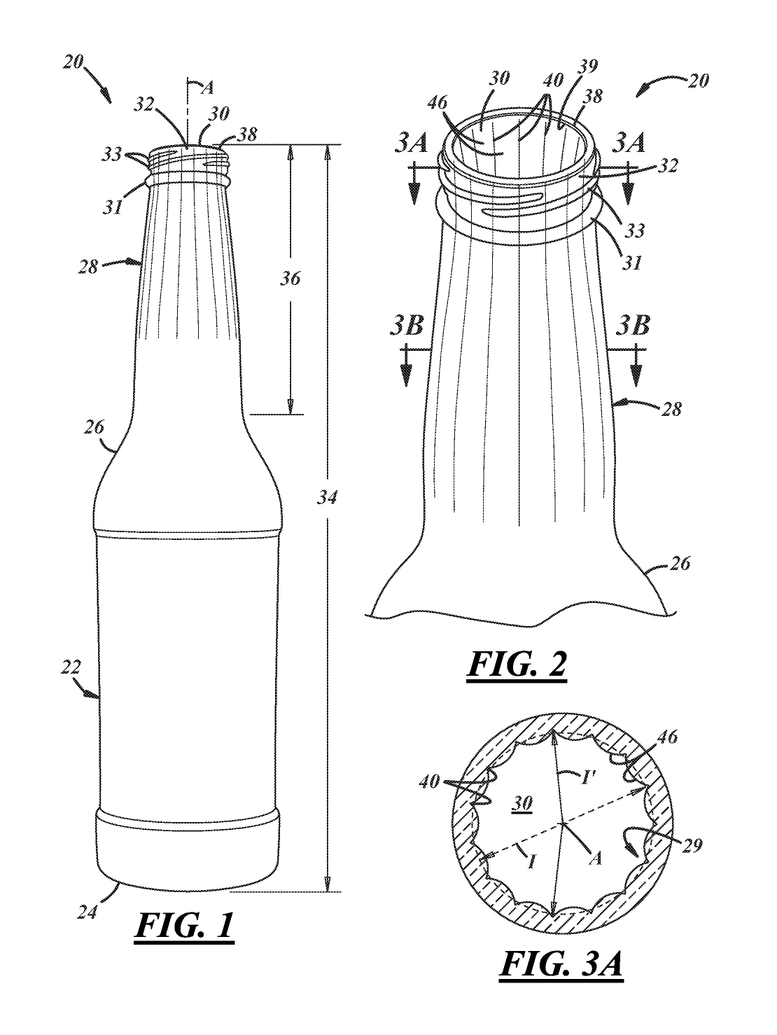

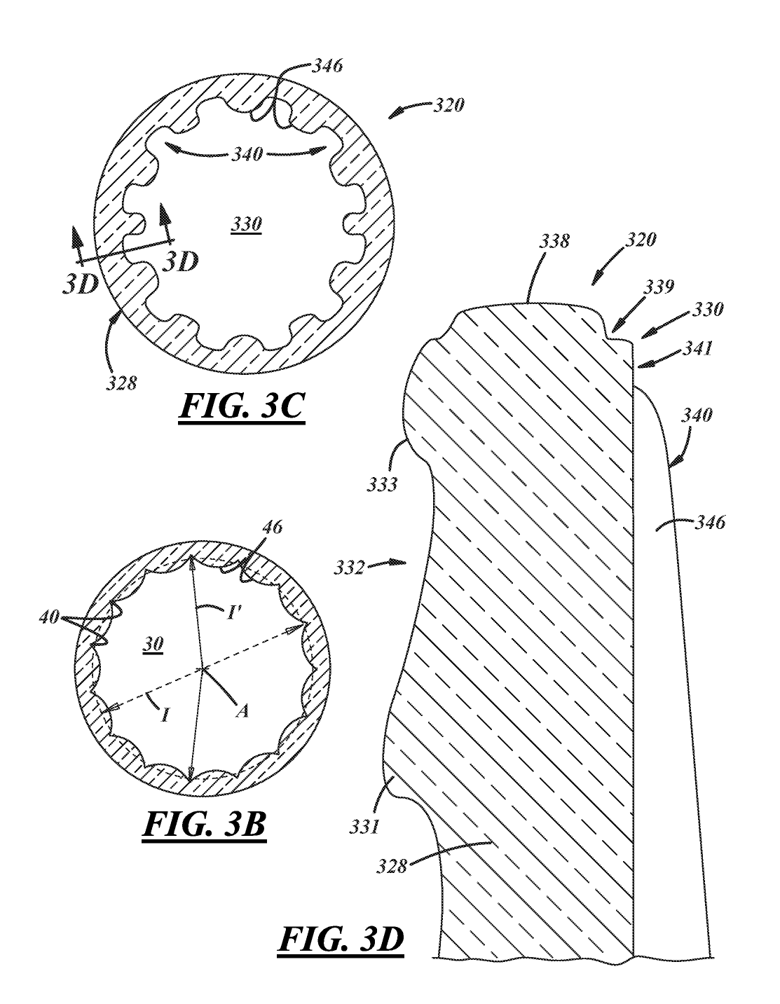

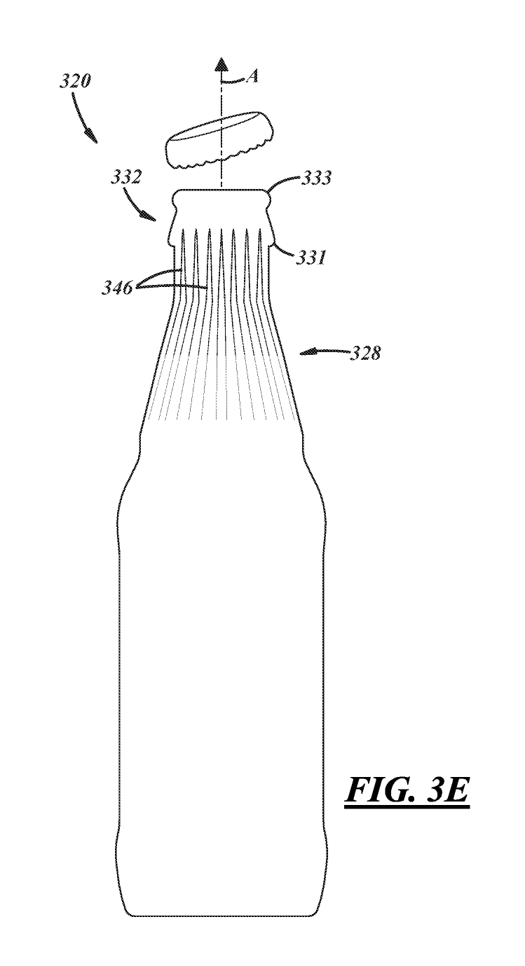

FIG. 1 illustrates a bottle 20 in accordance with one illustrative embodiment of the present disclosure as including a bottle body 22, a closed base 24 terminating a lower portion of the body 22, a shoulder 26 extending from an upper portion the body 22, and a bottle neck 28 extending along a longitudinal central axis A of the bottle 20 from the shoulder 26 to a bottle lip or axially-facing sealing surface 38 (FIGS. 2 and 3). The neck 28 includes a neck finish 32 that has one or more features thereon for attachment of a desired closure (not shown). For example, the neck 28 may include a capping flange 31 and one or more threads or thread segments 33 to cooperate with corresponding threads on a threaded type of closure. As used herein, the term thread segment includes whole, partial, multiple, and/or an interrupted thread and/or thread segment. The neck finish 32 can instead include a crown thereon for engagement with a crimping type of closure, or any other suitable closure features. The neck finish 32 further includes a mouth 39 adjacent the axially-facing sealing surface 38 (best shown in FIG. 2).

The bottle 20 may be a longneck bottle having an overall height 34, and the neck 28 (including neck finish 32) having a neck height 36. For purposes of the present disclosure, the term “longneck bottle” is defined as a bottle in which the height 36 of the bottle neck is at least 25% of the overall bottle height 34. In illustrative embodiments of the present disclosure, the neck height 36 is in the range of 33% to 40% of bottle height 34. The heights 34, 36 may be measured to the sealing surface 38 that axially terminates the neck 28 and neck finish 32. Also, the bottle 20 may be a narrow neck bottle, having a thread diameter (so-called “T” dimension) or a crown diameter (so-called “A” dimension) not more than 38 mm. The neck 28 and neck finish 32 may have external surfaces that are circular in cross section. In an embodiment, and as will be described in greater detail below, the bottle 20 may also be a wide-mouth bottle wherein the insider diameter of the neck finish 32 proximate the mouth 39 is greater than, for example, 26 mm. In such an embodiment, the inside diameter of the neck finish 32 may become progressively narrower as the neck finish 32 extends from the mouth 39 in an axial direction away from the sealing surface 38 such that at least a portion of the neck 28 and/or neck finish 32 has a funnel or conical shape.

The bottle 20 is of one-piece integrally formed construction, preferably glass, metal, or plastic construction. (The term “integrally formed construction” does not exclude one-piece integrally molded layered glass constructions of the type disclosed for example in U.S. Pat. No. 4,740,401, or one-piece glass or metal bottles to which other structure is added after the bottle-forming operation.) Longneck glass bottles can be fabricated by press-and-blow and/or blow-and-blow manufacturing operations, or by any other suitable technique(s).

In accordance with the present disclosure, and as described in U.S. patent application Ser. No. 13/709,288, filed on Dec. 10, 2012 (Assignee's Docket No. 19145), assigned to the assignee hereof, and hereby incorporated herein by reference in its entirety, the bottle neck 28 may include one or more non-circular, circumferentially-spaced, radially-facing internal or interior surfaces 29 (shown in FIG. 3A). For example, at least one internal axial feature is formed in the bottle neck 28 for affecting flow of liquid through the bottle neck 28, and the neck interior 30 thereof, in particular, during dispensing. In an embodiment, at least a portion of the neck 28 adjacent to, radially inward of, and/or axially corresponding to the neck finish 32 includes the non-circular internal surfaces 29. In addition to affecting flow through the bottle neck 28, the same and/or one more different axial features formed in the bottle neck 28 also may be configured or adapted to ream or abrade a piece of fruit, for example, a slice or wedge of citrus (e.g., a lime, an orange, or another type of citrus) as it is introduced into the bottle 20 and moves through the neck finish 32 and neck 28, thereby maximizing the amount of juice that is squeezed from piece of fruit. In any event, and as will be discussed in further detail below, the axial feature(s) may be formed by corresponding features of a press-and-blow or blow-and-blow plunger, and do not require use of corresponding features in blank or blow molds or in neck rings. Accordingly, conventional blank molds, blow molds, and/or neck rings may be used, in conjunction with the disclosed plunger(s).

In the embodiment of FIGS. 1-3B, the bottle neck 28 is fluted. For example, the internal axial feature takes the form of a plurality of internal grooves 40 that extend axially along the axis A that forms the central axis of the bottle 20. The grooves 40 are formed into the interior surface 29 of the bottle 20 so as to extend radially-outwardly, as opposed to projections formed onto the interior surface 29 of the bottle 20 that project radially-inwardly. The grooves 40 may be substantially identical and at uniform angular or circumferential spacing from each other. As liquid product, such as beer, soda or other beverage is dispensed from the bottle 20 out of the neck interior 30, the grooves 40 promote venting of gas into and/or out of the bottle 20. Improved venting leads to an increased liquid flow rate out of the bottle 20, for example, up to 10% better.

In an embodiment, the axial feature may additionally or alternatively include or comprise one or more projections 46 that extend axially along the axis A of the bottle 20. The projections 46 may be referred by a number of different names and/or take any number of forms, for example, corrugations, protrusions, fillets, lobes, ribs, flutes, etc. The projections 46 may be formed in or onto the interior surface 29 of the bottle 20, and the neck 28 thereof, in particular, so as to project radially-inwardly into the neck interior 30. Each projection 46 has a radially-innermost end portion that may be radiused or rounded, or alternatively, may be pointed or have a sharp edge (i.e., the lateral, radially-projecting sides of the projection 46 meet or terminate at a point to form a pointed end of the projection 46). Further, in one embodiment, each of the projections 46 may have a constant width and depth throughout its length; while in other embodiments, the width and/or depth of one or more projections 46 may vary from one end of the projection 46 to the other (e.g., the width and/or depth may progressively increase or decrease).

In an instance wherein the axial feature includes both one or more grooves 40 and one or more projections 46, the groove(s) 40 and the projection(s) 46 may be arranged such that each groove 40 is adjacent to at least one projection 46, and vice versa. Where there is a plurality of grooves 40, each pair of adjacent grooves 40 may have an intervening projection 46 disposed between the grooves 40. As with the grooves 40 described above, the projections 46 may be substantially identical in size and/or shape and at uniform angular circumferential spacing from each other. Alternatively, the projections 46 may not be identical in either size or shape, and/or may be non-uniformly spaced. In any instance, as a piece of fruit is introduced into the bottle 20 and moves through the neck finish 32 and neck 28, the projections 46 serve to ream or abrade the fruit, thereby maximizing the amount of juice that is squeezed therefrom and guiding it through the neck interior 30.

In an embodiment, the configuration of the grooves 40 and/or the projections 46 is such that the surface area of the opening of the neck interior 30 is substantially the same as it would be for a conventional bottle that is otherwise identical to the bottle 20 except for the grooves 40 and/or the projections 46. Conventional longneck bottles have necks and neck interiors that are typically cylindrical or conical and, in any event, circular in cross-section. Bottle necks are specified by a so-called “I” dimension that is a major inside diameter of the neck interior and a so-called “E” and “T” dimensions that are major outside diameters of the neck finish and the threads, respectively. As used herein, the terminology circular neck interior means circle-shaped in cross-section perpendicular to the bottle axis A, and uninterrupted over a full circumference.

As illustrated in FIGS. 3A and 3B, the bottle 20 has a non-circular neck interior with a major inside diameter I′ that is larger than a major inside diameter I of a circular neck interior of a conventional bottle, which is otherwise identical to the bottle 20 except for the grooves 40 and projections 46. But the circular neck finish 32 and threads 33 have “E” and “T” dimensions that are substantially the same as the conventional bottle. As used herein, the term substantially means within manufacturing tolerances commonly used in the art. Accordingly, the wall of the neck 28 and neck finish 32 may be both thinner and thicker than the thickness of conventional bottles.

Referring now to FIGS. 3C and 3D, a bottle 320 includes a neck 328 with a neck finish 332 including a capping flange 331, a crown 333, and an axial end surface or lip 338. The bottle 320 also includes a neck interior 330 that is fluted to include a plurality of grooves 340. In an embodiment, the grooves 340 extend all the way, or substantially all the way, to the lip or surface 338. In another embodiment, however, the grooves 340 extend axially toward the lip 338 but may stop short thereof. For example, an axial gap may be provided between the lip 338 and the axial ends of the grooves 340. Also, a stepdown or step 339 may be provided axially and radially between the lip 338 and the axial ends of the grooves 340. Likewise, a cylindrical portion 341 may be provided axially between the axial ends of the grooves 340 and the step 339. In any event, in an embodiment, one or more of the grooves 340 may extend axially along the interior surface of the neck 328 and axially overlap at least a portion of the neck finish 332 such that at least a portion of one or more of the grooves 340 may be axially-aligned with at least a portion of the neck finish 332.

In an embodiment, the neck 328 further or alternatively may include one or more projections 346 that project radially-inwardly into the neck interior 330 from the interior surface of the neck. As with the grooves 340, the projections 346 may extend all the way to the lip or surface 338, or alternatively, may extend axially toward the lip or surface 338 but stop short thereof. Further, one or more of the projections 346 may extend axially along the interior surface of the neck 328 and axially overlap at least a portion of the neck finish 332 such that at least a portion of one or more of the projections 346 may be axially-aligned with at least a portion of the neck finish 332. In such an embodiment, one or more of the projections 346 may terminate at a point that is a predetermined axial distance below the lip or sealing surface 338 and that may be axially-aligned with at least a portion of the neck finish 332. For example, the projections 346 may terminate at a point that is located between the sealing surface 338 and the capping flange 331, and in one illustrative embodiment, at a point located between the capping flange 331 and the crown 333 (as shown in FIG. 3E). More particularly in one illustrative embodiment, the projection(s) 346 may terminate at a point that is 5-15 mm (e.g., 0.25-0.50 in.) below the lip or sealing surface 338. While a particular axial distance range set forth above has been expressly provided, it will be appreciated by those having ordinary skill in the art that the provided range includes all ranges and sub-ranges thereof, and that distances and ranges other than that expressly provided herein remain within the spirit and scope of the present disclosure.

In any event, in an embodiment wherein the projections 346 stop short of the lip or surface 338, an axial gap may be created or provided between the sealing surface 338 and the axial ends of the projections 346. As with the embodiment described above, a stepdown or step 339 may be provided axially and radially between the lip or surface 338 and the axial ends of the projections 346. Likewise, a cylindrical portion 341 may be provided axially between the axial ends of the projections 346 and the step 339. In any instance, the axial gap formed between the lip or surface 338 and the axial ends of the projections 346 provides both a lead-in for the introduction of a piece of fruit to the bottle 320, and an area within the bottle neck 328 where juice from an introduced piece of fruit may accumulate so that it can drain into the neck interior 330 rather than run over the lip or surface 338, and therefore, the outside of the bottle 320,as may occur with conventional bottles.

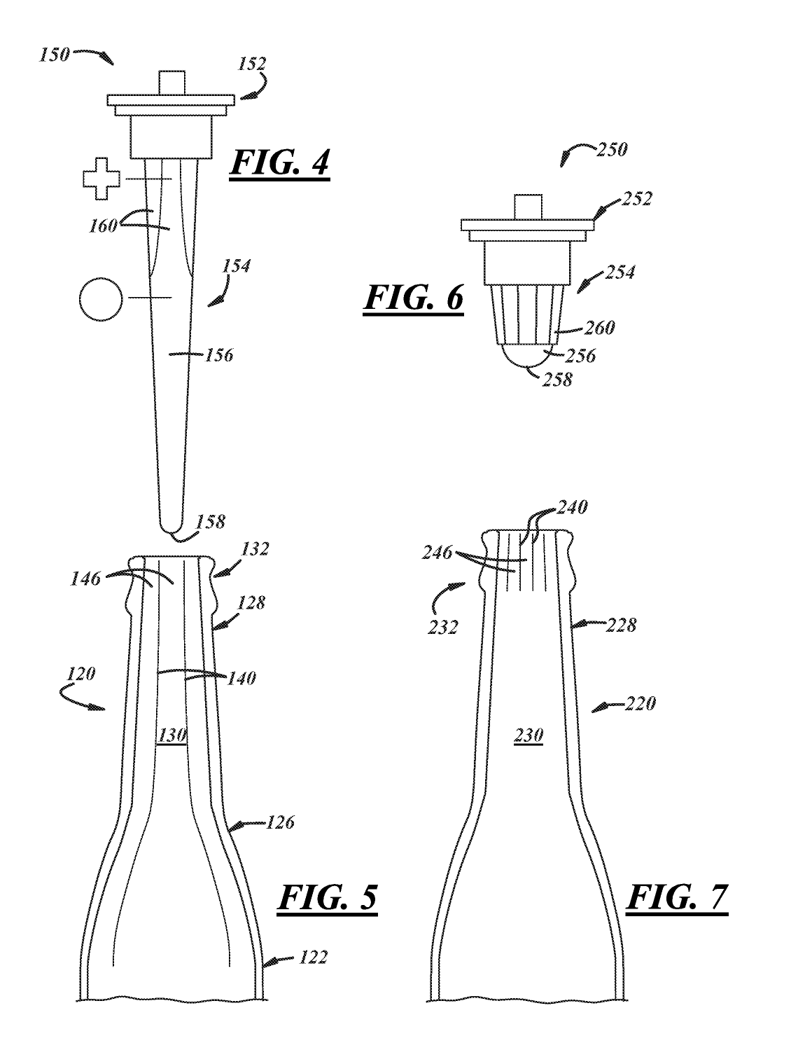

In one illustrative embodiment, and with reference to FIG. 4, a press-and-blow plunger 150 includes a base 152 and a forming body 154 extending from the base and including a smooth conical portion 156 terminating in a rounded tip 158, and a groove forming portion 160 between the tip 158 and the base 152. In a press-and-blow process, the forming body 154 forms neck, shoulder, and body interior surfaces of a parison used to form a bottle. In particular, the groove forming portion 160 is used to form grooves and/or define projections in the parison that ultimately become grooves and projections in a bottle after the parison is blown into the shape of the bottle. In this example, the groove forming portion 160 has a plus-shaped or cross-shaped cross-section. This type of geometry may be used to produce a container neck interior having a shape like that illustrated in FIG. 15.

Also in this embodiment, and also with reference to FIG. 5, because the press-and-blow plunger 150 (FIG. 4) extends deep into the parison, grooves 140 and/or projections 146 may be formed not only in the container neck interior 130 but also throughout the entire length of the bottle neck 128 and shoulder 126 and partially into the bottle body 122. In other embodiments, the length of the groove forming portion 160 (FIG. 4) can be selected to correspond to a desired length of the grooves and/or projections in the bottle 120. For example, the grooves 140 and/or projections 146 can extend partially into the shoulder 126, only partially into the neck 128 below a container neck finish 132, or partially into the neck finish 132. Accordingly, the plunger groove length is sufficient to form grooves and/or projections in at least a portion of a neck interior 130 axially and radially corresponding to the neck finish 132, and at least a portion of the rest of the neck interior 130 below the neck finish 132.

In another illustrative embodiment, and with reference to FIG. 6, a blow-and-blow plunger 250 includes a base 252 and a forming body 254 extending from the base 252 and including a smooth conical portion 256 terminating in a rounded tip 258, and a groove forming portion 260 between the tip 258 and the base 252. In a blow-and-blow process, the forming body 254 typically forms just a short neck interior portion of a parison used to form a bottle. Accordingly, the groove forming portion 260 is used to form grooves and/or define projections in the parison that ultimately become grooves and projections in a bottle after the parison is blown into the shape of the bottle. In this example, the groove forming portion 260 has a fluted cross-sectional shape. As used herein, the term cross-section means a section taken perpendicular to a longitudinal axis. This type of geometry may be used to produce a container neck interior having a shape like that illustrated in FIGS. 10A and 10B.

Also in this embodiment, and with reference to FIG. 7, because the blow-and-blow plunger extends shallow into the parison, grooves 240 and/or projections 246 will be formed in corresponding portion of the container neck interior 230 of a bottle neck 228. In some embodiments, the height and/or length of the groove forming portion 260 of the plunger body 254 may be configured such that the grooves 240 extend partially into the container neck 228 at least into a portion of the neck interior 230 axially and radially corresponding to a neck finish 232.

In either embodiment, the presently disclosed tooling and method can produce the internal axial features taller or longer than would be possible with embossments or debossments in a blank mold, for example, as disclosed in U.S. Patent Application Publication 2010/0264107.

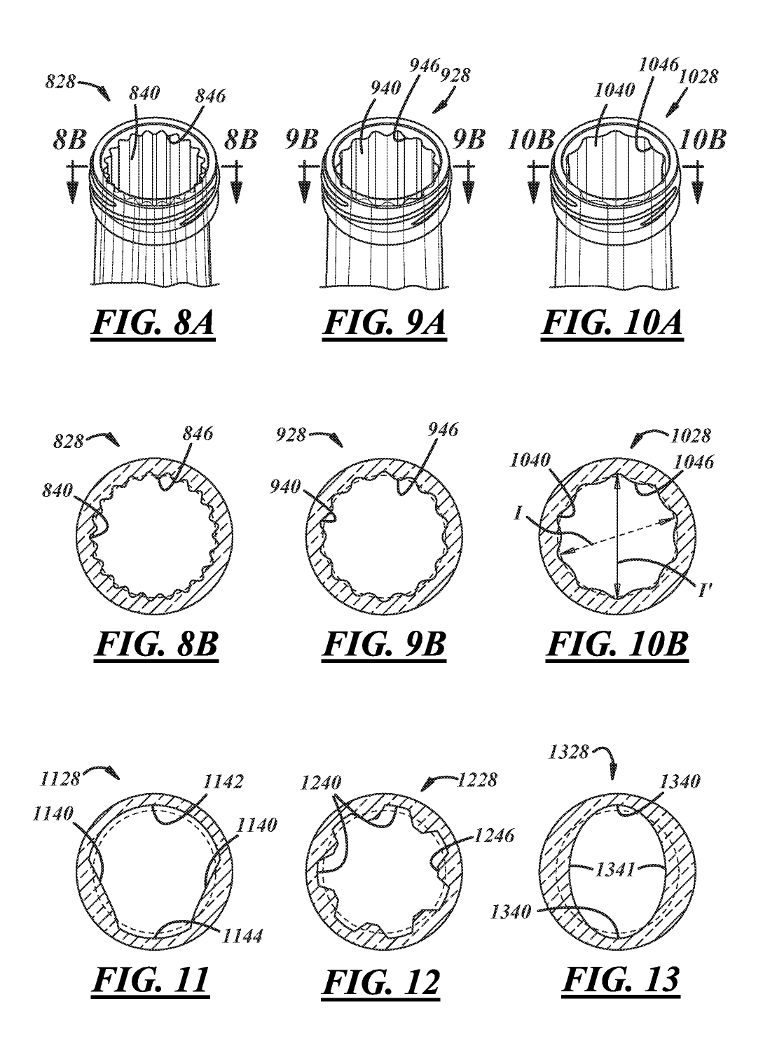

FIGS. 8A through 33 illustrate several other illustrative embodiments of longneck bottles having, in certain instances, projections projecting radially-inwardly into the neck interior. These embodiments are similar in many respects to the embodiment of FIGS. 1 through 7, and like numerals between the embodiments generally designate like or corresponding elements throughout the several views of the drawing figures. Accordingly, the descriptions of all of the embodiments are incorporated into one another. Additionally, the description of the common subject matter generally may not be repeated here.

FIGS. 8A and 8B illustrate a bottle neck 828 that is fluted to include an undulating circumferential profile having twenty-one grooves or flutes 840, and an equal number of projections 846.

FIGS. 9A and 9B illustrate a bottle neck 928 that is fluted to include an undulating circumferential profile having fourteen grooves or flutes 940, and an equal number of projections 946.

FIGS. 10A and 10B illustrate a bottle neck 1028 that is fluted to include an undulating circumferential profile having ten grooves or flutes 1040, and an equal number of projections 1046.

FIG. 11 illustrates a bottle neck 1128 and that is lobed to include a clamshell shaped profile. For example, the clamshell shaped profile may have a first circular portion 1142, a second, smaller circular portion 1144, and tangential lobes 1140 connecting the circular portions 1142, 1144. The tangential lobes 1140 may be straight or curved, and in an embodiment, may comprise projections such as those described elsewhere above.

FIG. 12 illustrates a bottle neck 1228 that is fluted to include a spline or cog shaped profile. For example, the cog shaped neck interior includes seven grooves or flutes 1240, and an equal number of projections 1246, but may include any suitable quantity of grooves/flutes and/or proj ections.

FIG. 13 illustrates a bottle neck 1328 that is fluted to include an elliptical shaped profile. For example the elliptical shaped neck interior may include opposed long sides 1341 and opposed short sides 1340 connecting the opposed long sides 1341. Although, the internal surface of the neck 1328 may be elliptical in cross section, the external surface of the neck 1328 may be circular in cross section.

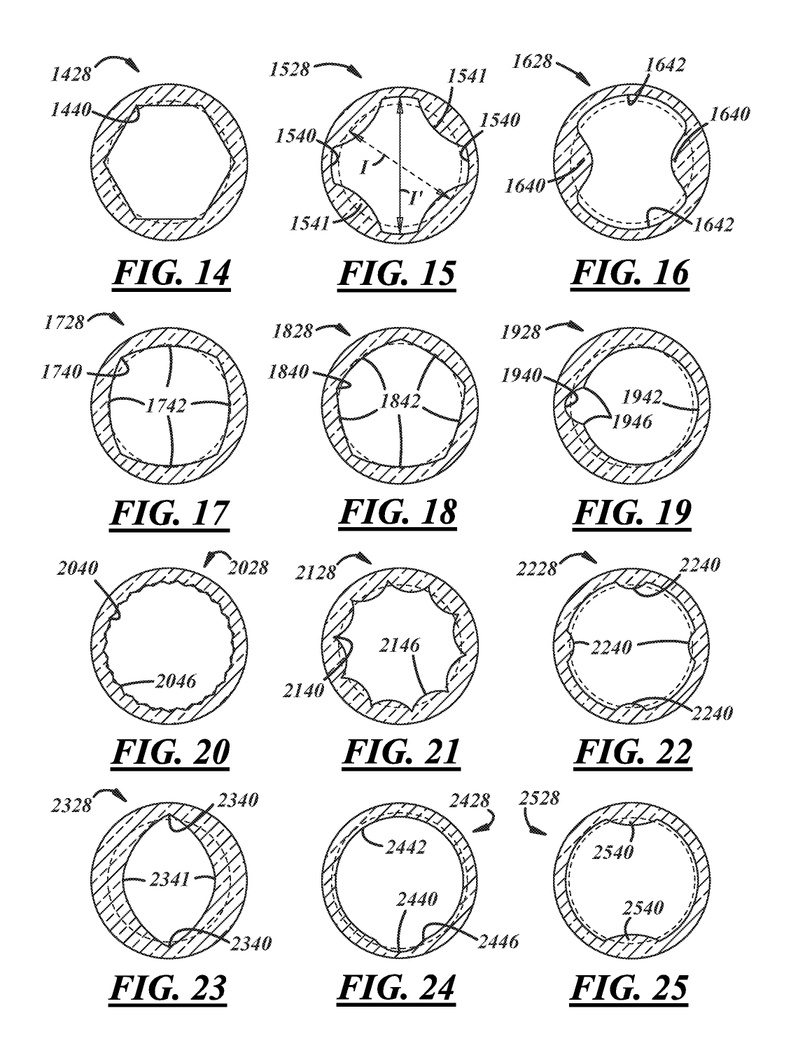

FIG. 14 illustrates a bottle neck 1428 that is fluted to include a hexagonal shaped profile, including apexes 1440.

FIG. 15 illustrates a bottle neck 1528 that is fluted to include a generally cross shaped profile and, more particularly, a filleted cross shaped profile. For example, the cross shaped neck interior may include two pairs of opposed circular portions 1540 and excurvate fillets 1541 between the circular portions 1540. In an embodiment, the fillets 1541 may comprise projections such as those described elsewhere above.

FIG. 16 illustrates a bottle neck 1628 that is lobed to include a generally badge shaped profile. For example, the badge shaped neck interior may include opposed circular portions 1642 and excurvate fillets 1640 between the circular portions 1642. In an embodiment, the fillets 1640 may comprise projections such as those described elsewhere above.

FIG. 17 illustrates a bottle neck 1728 that is fluted to include a generally square shaped profile and, more particularly, a rounded off square shaped profile. For example, the square shaped neck interior may include two pairs of opposed incurvate portions 1742 and apexes 1740 thereb etween.

FIG. 18 illustrates a bottle neck 1828 that is fluted to include a generally pentagon shaped profile and, more particularly, a rounded off pentagon shaped profile. For example, the pentagon shaped neck interior may include five incurvate sides 1842 and apexes 1840 therebetween.

FIG. 19 illustrates a bottle neck 1928 that is fluted to include a keyway shaped profile. For example the keyway shaped neck interior may include a circular portion 1942 and a rounded keyway portion 1940 overlapping the circular portion 1942. In an embodiment, the junction or transition point(s) between the circular and keyway portions 1942, 1940 may comprise or form one or more projections 1946.

FIG. 20 illustrates a bottle neck 2028 that is fluted to include a sawtooth shaped profile. For example the sawtooth shaped neck interior may include twenty-five grooves or flutes 2040, and an equal number of projections 2046.

FIG. 21 illustrates a bottle neck 2128 that is fluted to include a sun shaped profile, for example, which may include ten grooves or flutes 2140, and an equal number of projections 2146. In this example the grooves include sharp apexes, in contrast to the smooth apexes shown in FIGS. 8A through 10B.

FIG. 22 illustrates a bottle neck 2228 that is lobed. For example, the lobed bottle neck interior has two pairs of diametrically opposed radially inwardly projecting lobes 2240. In an embodiment, the lobes 2240 may comprise projections such as those described elsewhere above.

FIG. 23 illustrates a bottle neck 2328 that is fluted to include incurvate sides 2341 that intersect to establish diametrically opposed grooves and flutes 2340 with acute apexes.

FIG. 24 illustrates a bottle neck 2428 that is fluted to include a keyway shaped profile similar to that shown in FIG. 19. For example, the keyway shaped neck interior may include circular portion 2442 and a rounded keyway portion 2440 overlapping the circular portion 2442. In an embodiment, the junction or transition point(s) between the circular and keyway portions 2442, 2440 may comprise or form one or more projections 2446.

FIG. 25 illustrates a bottle neck 2528 that is lobed to include a generally badge shaped profile similar to that of FIG. 16 but with somewhat less pronounced radially inwardly projecting lobes 2540. In an embodiment, the lobes 2540 may comprise projections such as those described elsewhere above.

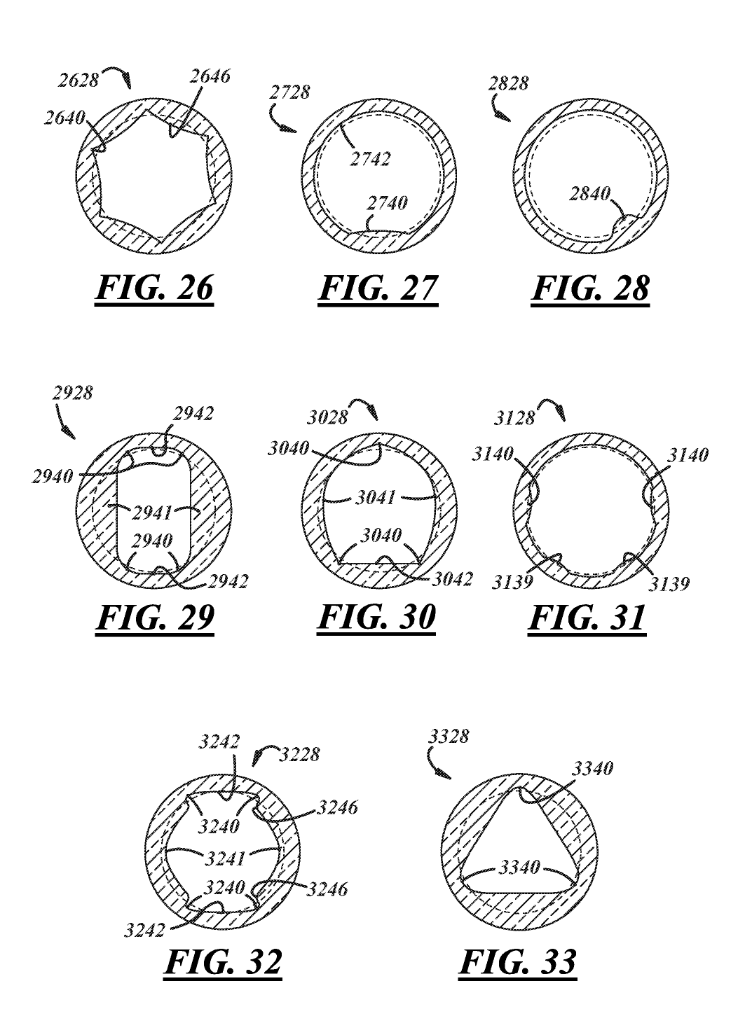

FIG. 26 illustrates a bottle neck 2628 similar to that illustrated in FIG. 14 and/or FIG. 21 but with only six grooves or flutes 2640 wherein the grooves have sharp apexes and adjacent grooves have one or more projections 2646 disposed therebetween.

FIG. 27 illustrates a bottle neck 2728 that is lobed. For example, the lobed profile includes a circular portion 2742 and a lobe 2740 projecting radially inwardly and having and an excurvate surface. In an embodiment, the lobe 2740 may comprise a projection such as that described elsewhere above.

FIG. 28 illustrates a lobed bottle neck 2828 similar to that of FIG. 27. In this embodiment however, the lobed profile includes a more pronounced lobe 2840. In an embodiment, the lobe 2840 may comprise a projection such as that described elsewhere above.

FIG. 29 illustrates a bottle neck 2928 that is fluted to include a generally rectangular shape and, more particularly, a filleted rectangular profile. For example, the rectangular shaped neck interior includes diametrically opposed short sides 2942 in diametrically opposed long sides 2941 connecting the short sides 2942 by incurvate fillets 2940.

FIG. 30 illustrates a bottle neck 3028 that is fluted to include a generally archway shaped profile and, more particularly, a filleted archway shaped profile. For example, the archway shaped neck interior includes opposed incurvate portions 3041 and a straight portion 3042 connecting the opposed excurvate portions 3041, and apexes 3040 therebetween.

FIG. 31 illustrates a lobed bottle neck 3128 having a pair of diametrically opposed radially inwardly extending lobes 3140, and a pair of adjacent radially inwardly extending lobes 3139 on one side of the opposed lobes 3140. In an embodiment, the lobes 3140 and/or the lobes 3139 may comprise projections such as those described elsewhere above.

FIG. 32 illustrates a bottle neck 3228 that is fluted to include a generally lantern shaped profile. For example, the lantern shaped profile may include diametrically opposed incurvate portions 3241 and diametrically opposed crown portions 3242 between and connecting the incurvate portions 3241, and incurvate fillets 3240. In an embodiment, the junction or transition point(s) between the incurvate and crown portions 3241, 3242 may comprise or form one or more projections 3246.

FIG. 33 illustrates a bottle neck 3328 that is fluted to include a generally triangular shaped profile and, more particularly, a filleted triangular shaped profile. For example, the triangular shaped neck interior includes three apexes 3340, which may be rounded or filleted.

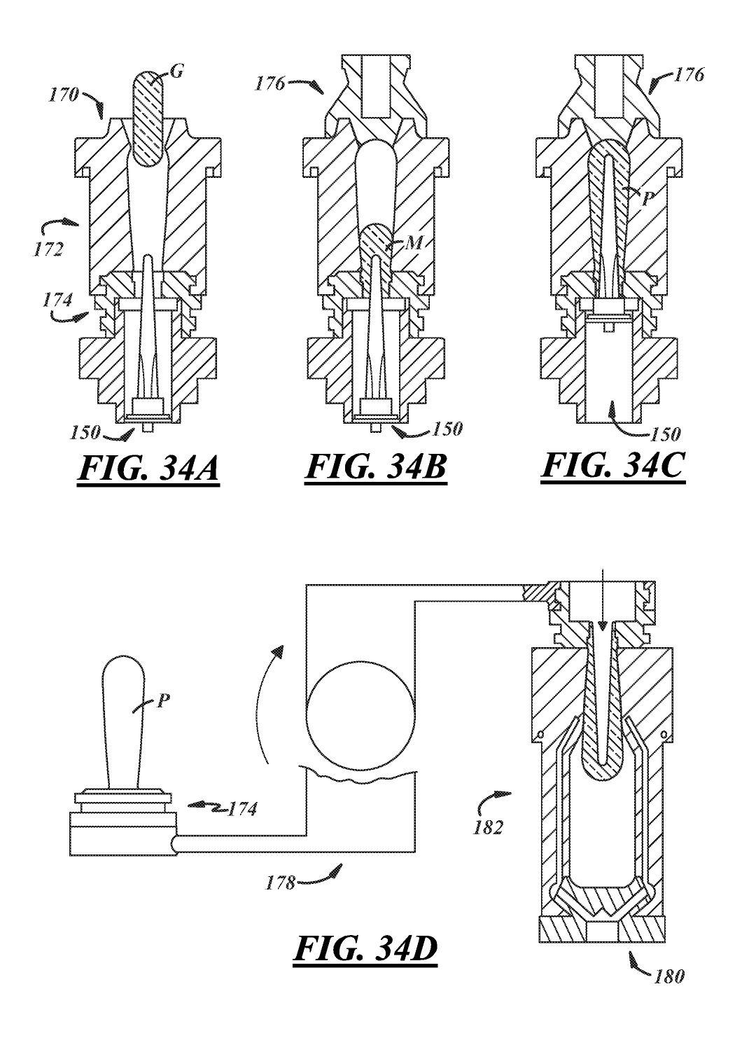

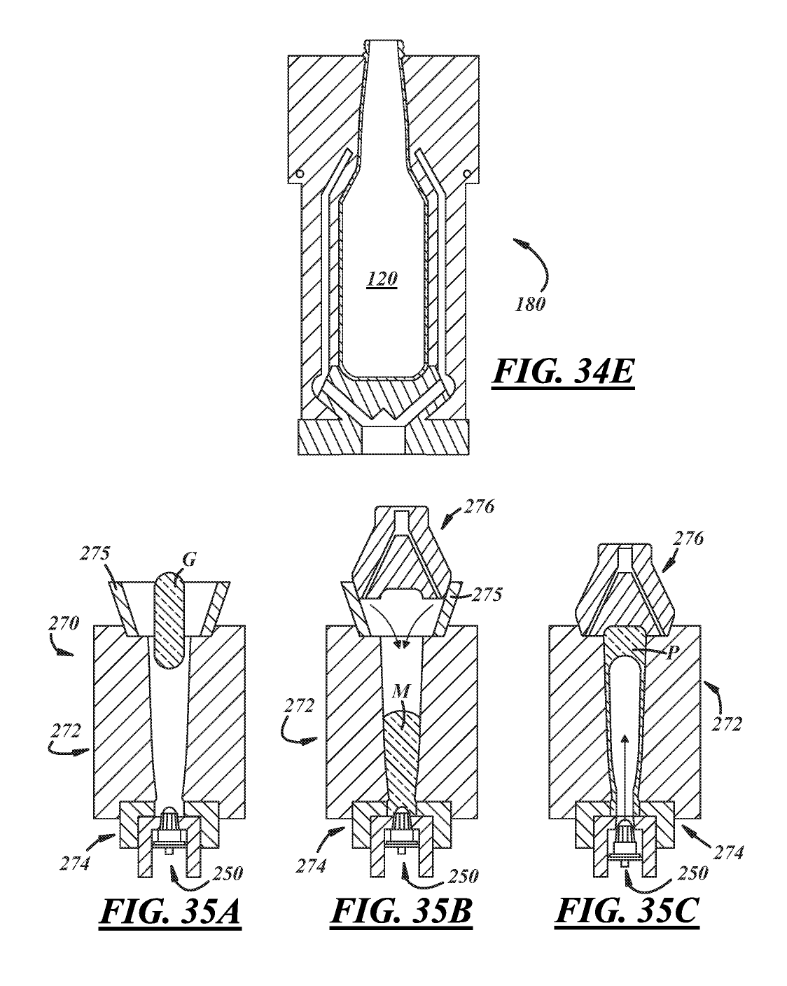

FIGS. 34A-34E illustrate an example press and blow container manufacturing process and tooling including a blank side (FIGS. 34A-34C), a blow side (FIGS. 34D-34E), and a transfer stage therebetween (FIG. 34D). On the blank side, in FIG. 34A, a gob G of molten glass is illustrated being dropped into an open parison mold or blank mold 170 including a blank mold body 172, a neck ring 174, and the press and blow plunger 150. Next, in FIG. 34B, a baffle 176 is shown in position closing the blank mold 170, wherein molten glass M is shown settled in the bottom of the blank mold 170 around the plunger 150. Subsequently, in FIG. 34C, the plunger 150 is shown in a fully extended position, wherein a parison P is formed around the plunger 150 within the blank mold body 172. At the transfer stage, in FIG. 34D, a transfer mechanism 178 inverts the parison P and the neck ring 174 carrying the parison P and delivers them to the blow side. On the blow side, the parison P is shown within a blow mold 180 including a blow mold body 182, wherein blow gas is delivered through the neck ring into an interior of the parison P. Thereafter, in FIG. 34E, the bottle 120 is shown fully blown and stretched within the blow mold 180 and the neck ring has been removed so that the blow mold 180 can be opened and the bottle 120 removed.

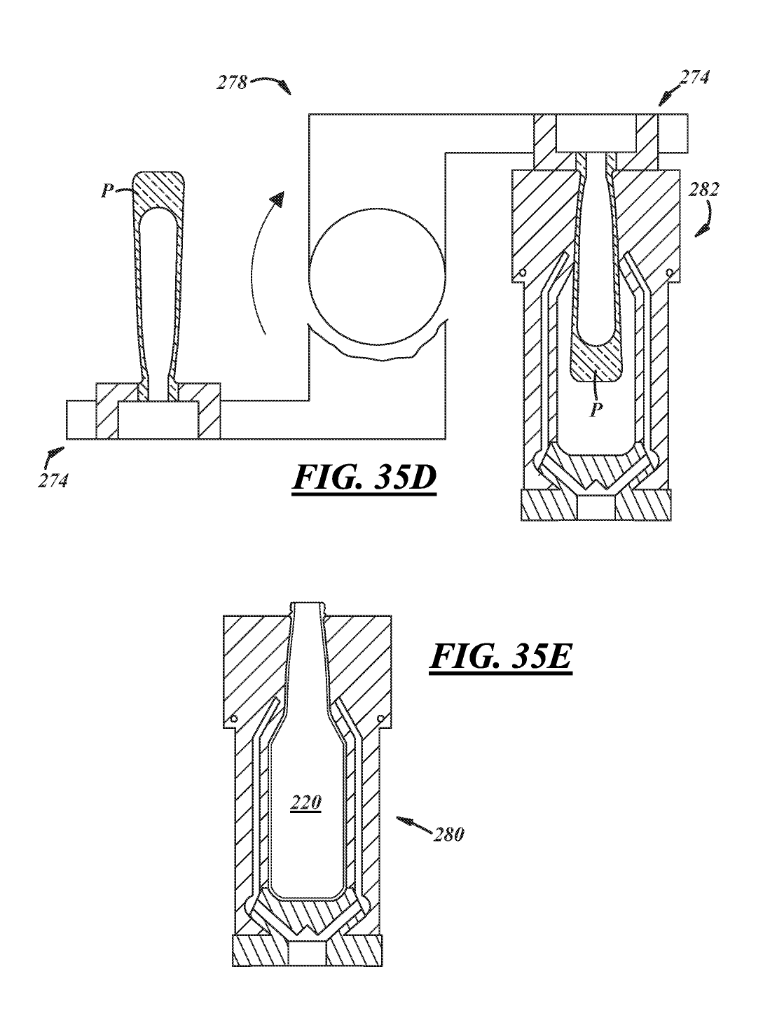

FIGS. 35A-35E illustrates an example blown blow container manufacturing process including a blank side (FIGS. 35A-35C), a blow side (FIGS. 35D-35E), and a transfer stage therebetween (FIG. 35D). On the blank side, in FIG. 35A, a gob G of molten glass is illustrated being dropped into an open parison mold or blank mold 270 including a blank mold body 272, a neck ring 274, and the blow-and-blow plunger 250. Next, in FIG. 35B, a baffle 276 is shown in position in contact with a funnel 275 and communicating settle gas against molten glass M, wherein the molten glass M settles at the bottom of the mold 270 within the neck ring 274 and against the plunger 250. Subsequently, in FIG. 35C, the plunger 250 is shown in a retracted position to allow counter blow gas to enter the molten glass and establish a parison P having an interior cavity formed by the counter blow gas and exterior surfaces in contact with interior surfaces of the blank mold body 272 and the baffle 276. At the transfer stage, in FIG. 35D, a transfer mechanism 278 inverts the parison P and the neck ring 274 carrying the parison P and delivers them to the blow side. On the blow side, the parison P is shown within a blow mold including a blow mold body 282, wherein blow gas is delivered through the neck ring 274 into the interior of the parison P. Thereafter, in FIGS. 35E, the bottle 220 is shown fully blown and stretched within the blow mold 280 and the neck ring has been removed so that the blow mold 280 can be opened in the bottle 220 removed.

As briefly described above, in an embodiment, the bottle may comprise a wide-mouth bottle wherein the inside diameter of the neck, and the neck finish thereof, in particular, is at its greatest proximate the mouth and then progressively narrows as the neck finish extends in an axial direction away from the sealing surface. As a result, at least a portion of the neck and/or neck finish has a funnel or conical shape (i.e., the interior surface 29 of the neck 28 tapers radially-inwardly from the mouth 39 to a point axially beneath the mouth).

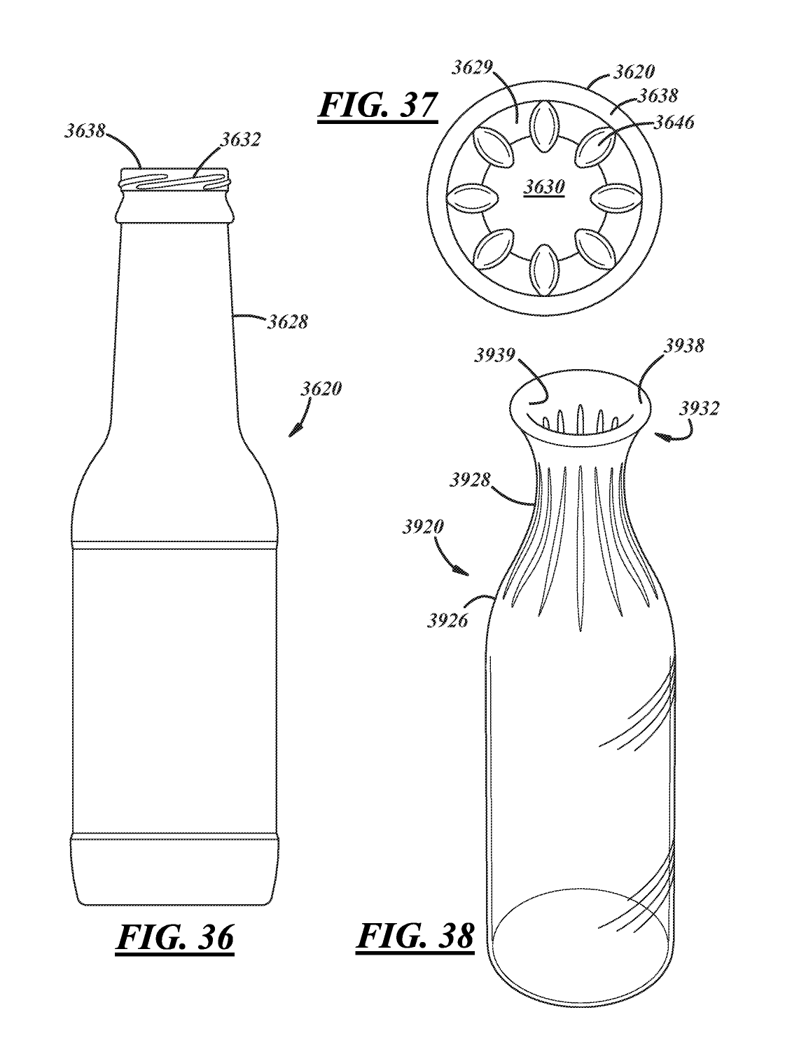

For example, FIGS. 36 and 37 illustrate an embodiment of a wide-mouth bottle 3620 having a neck 3628 and a neck finish 3632, wherein at least a portion of the neck finish 3632 has a conical or funnel shape. In an embodiment, the inside diameter of neck 3628 proximate the mouth 3639 may be on the order of, for example, 38-53 mm and may taper to an inside diameter on the order of, for example, 26 mm as the neck 3628 extends from the mouth 3639 to a point axially beneath the mouth 3639. In addition to the neck 3628 having a funnel-shaped portion, in an embodiment, once the inside diameter narrows down to a predetermined minimum inside diameter (e.g., 26 mm), the inside diameter may then progressively increase as the neck 3628 extends further away from the mouth 3639 and towards the shoulder 3626 of the bottle 3620. As a result, at least a portion of the neck 3628 may have a reverse or upside down funnel or conical shape (i.e., the interior surface of the neck 3628 progressively widens radially-outwardly).

It will be appreciated that the aforementioned dimensions and interior neck geometries are provided for illustrative purposes only and that the present disclosure is not intended to be limited to any particular dimensions or geometries. In any event, one advantage of at least a portion of the neck 3628 having a funnel or conical shape is that the larger diameter neck portion allows for the relatively easy introduction of a piece of fruit into the bottle, while the smaller diameter portion(s) help to squeeze the fruit as it progresses or moves through the neck interior 3630.

As shown in FIG. 36, in an embodiment, the outside diameter of the neck 3628 may be relatively constant between the neck finish 3632 (or mouth 3639) and a shoulder 3626 of the bottle 3620, or may progressively increase as the neck 3628 extends from the neck finish 3632 (or mouth 3639) towards the shoulder 3626, regardless of the inside diameter of the neck 3628 and/or neck finish 3632. In other embodiments, however, the outside diameter may have a different geometry, for example, it may track or mirror the inside neck diameter.

More specifically, FIG. 38 depicts a bottle 3920 wherein both inside and outside diameters of the neck 3928 are at their greatest proximate the mouth 3939 and then progressively narrow as the neck 3928 or neck finish 3932 extends in an axial direction away from the sealing surface 3938 of the bottle 3920 towards the shoulder 3926. As a result, at least a portion of the neck 3928 or neck finish 3932 has a funnel or conical shape (i.e., both the interior and exterior surfaces of the neck 3928 taper radially-inwardly from the mouth 3939 to a point axially beneath the mouth 3939). In an embodiment, and as with the bottle 3620 described above, once the inside diameter narrows down to a predetermined minimum inside diameter (e.g., 26 mm) at the point axially beneath the mouth 3939, the inside and outside diameters of the neck 3928 may both progressively increase as the neck 3928 extends further away from the mouth 3939 and towards the shoulder 3926 of the bottle 3920. As a result, at least a portion of the neck 3928 may have a reverse or upside down funnel or conical shape (i.e., both the interior and exterior surfaces of the neck 3928 widen radially-outwardly).

In any of the embodiments described above, the bottle may include one or more axially-extending projections formed in or onto an interior surface of the bottle, and the neck thereof, in particular, so as to project radially-inwardly into the neck interior.

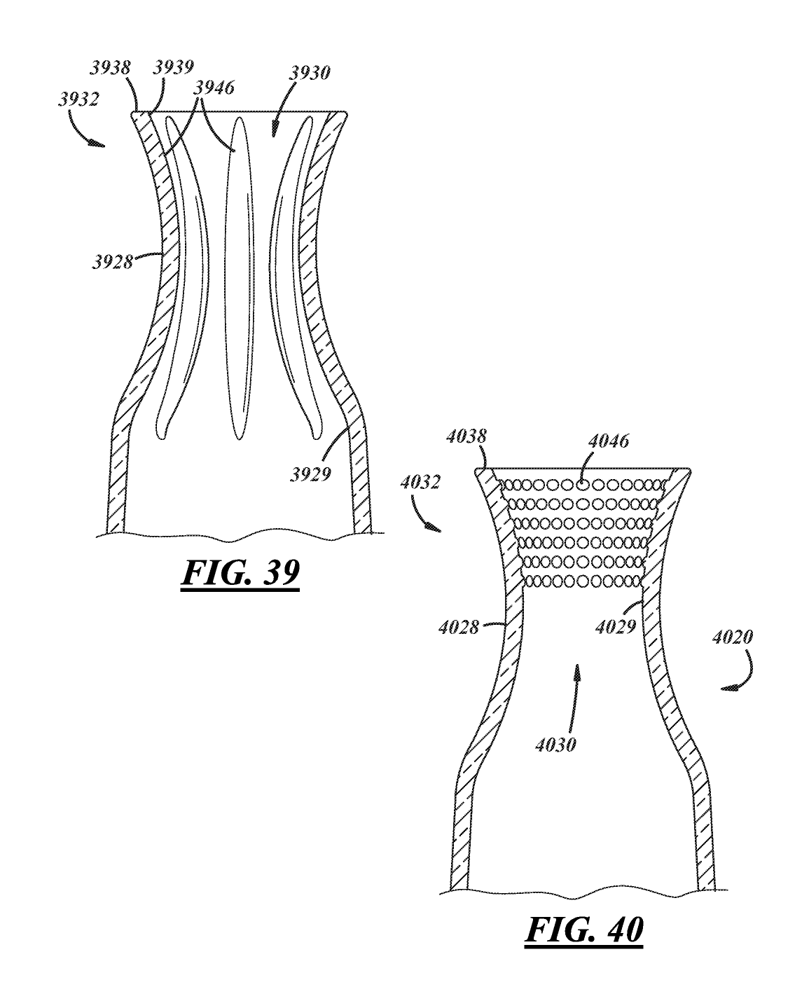

For example, and with reference to FIGS. 36-39, the bottles 3620, 3920 may include one or more axially-extending projections 3646, 3946 formed in or onto an interior surface 3629, 3929 of the respective bottle 3620, 3920, and the neck 3628, 3928 thereof, in particular, so as to project radially-inwardly into the neck interior 3630, 3930. The projections 3646, 3946 may take the same form and be arranged in the same manner as that or those described above, and therefore, the description relating to the projections set forth above will not be repeated but rather is incorporated here by reference. In an embodiment, however, the projections 3646, 3946 may extend all the way to the lip or sealing surface 3638, 3938 of the respective bottle 3620, 3920, or alternatively, may extend axially toward the sealing surface 3638, 3938, but stop short thereof. In either instance, at least a portion of one or more of the projections 3646, 3946 may extend axially along at least a portion of the interior surface 3629, 3929 of the neck 3628, 3928 that corresponds to the conically-shaped portion of the neck finish 3632, 3932 such that at least a portion of one or more of the projections 3646, 3946 axially overlaps and is axially-aligned with at least a portion of the neck finish 3632, 3932. Such an arrangement of the projection(s) 3646, 3946 allows for a piece of fruit to be pressed against and rotated along or about the projection(s) 3646, 3946 to ream or abrade the fruit prior to and/or while the fruit is being introduced into the bottle, thereby maximizing the amount of juice that is squeezed from the fruit and guiding it through the neck interior 3630, 3930.

It will be appreciated that bottles such as bottles 3620 and 3920 illustrated in FIGS. 36 and 37 and FIGS. 38 and 39, respectively, may be manufactured using the same or similar process as that described above with respect to FIGS. 34A-34E and/or FIGS. 35A-35E, and therefore, the description above will not be repeated but rather applies here with equal weight.

While the description above has been primarily with respect to an illustrative embodiment wherein the bottle includes axially-extending projections formed in or onto the interior surface of the bottle, and the neck thereof, in particular, in other embodiments, the projections may take a number of different forms.

For example, in addition to, or instead of, the projections comprising the axially-extending projections described above, the projections may comprise one or more (e.g., an array) of bumps or embossments formed in or onto an interior surface of the bottle, and the neck thereof, in particular, so as to project radially-inwardly into the neck interior. More particularly, and as illustrated in FIG. 40, the projections 4046 may comprise an array of bumps formed in or onto the interior surface 4029 of the bottle neck 4028. As with the axially-extending projections described above, in an embodiment, the array of bumps extends axially along the axis of the bottle 4020, and may extend all the way to the lip or sealing surface 4038 of the bottle 4020, or alternatively, may extend axially toward the sealing surface 4038 but stop short thereof (i.e., the array may terminate at a point that is a predetermined axial distance below the sealing surface 4038). At least a portion of the array may extend axially along at least a portion of the interior surface 4029 of the neck 4028 that corresponds to the neck finish 4032 such that at least a portion of the array, and therefore, one or more of the bumps thereof (i.e., projections 4046) axially overlaps and is axially-aligned with at least a portion of the neck finish 4032.

In an embodiment wherein at least a portion of the neck finish 4032 has a conical or funnel shape, as it does in FIG. 40, at least a portion of the array (i.e., one or more of the bumps or projections 4046 of the array) may be disposed at or on the conically-shaped portion of the neck finish 4032 such that at least one of the projections 4046 axially overlaps and is axially-aligned with at least a portion of the neck finish 4032. Additionally, in an embodiment, the array may extend circumferentially along the interior surface 4029 of the neck 4028. In such an embodiment, the array of bumps or projections 4046 may be contiguous such that it extends along the entire circumference of the neck 4028 without any definitive breaks. Alternatively, the array may extend along only a portion of the circumference of the neck 4028, or may comprise two or more discontinuous segments that are circumferentially-spaced about the circumference of the neck 4028.

As with the projections described elsewhere above, each projection 4046 has a radially-innermost end portion that may be radiused or rounded, or alternatively, may be pointed or have a shape edge. Additionally, each of the projections 4046 may be substantially identical in shape and/or size and at uniform circumferential spacing from each other. Alternatively, the projections 4046 may not be identical in size and/or shape, and/or may be non-uniformly spaced. Regardless, as a piece of fruit is introduced into the bottle 4020 and moves through the neck finish 4032 and neck 4028, the projections 4046 serve to ream or abrade the fruit, thereby maximizing the amount of juice that is squeezed therefrom and guiding through the neck interior 4030.

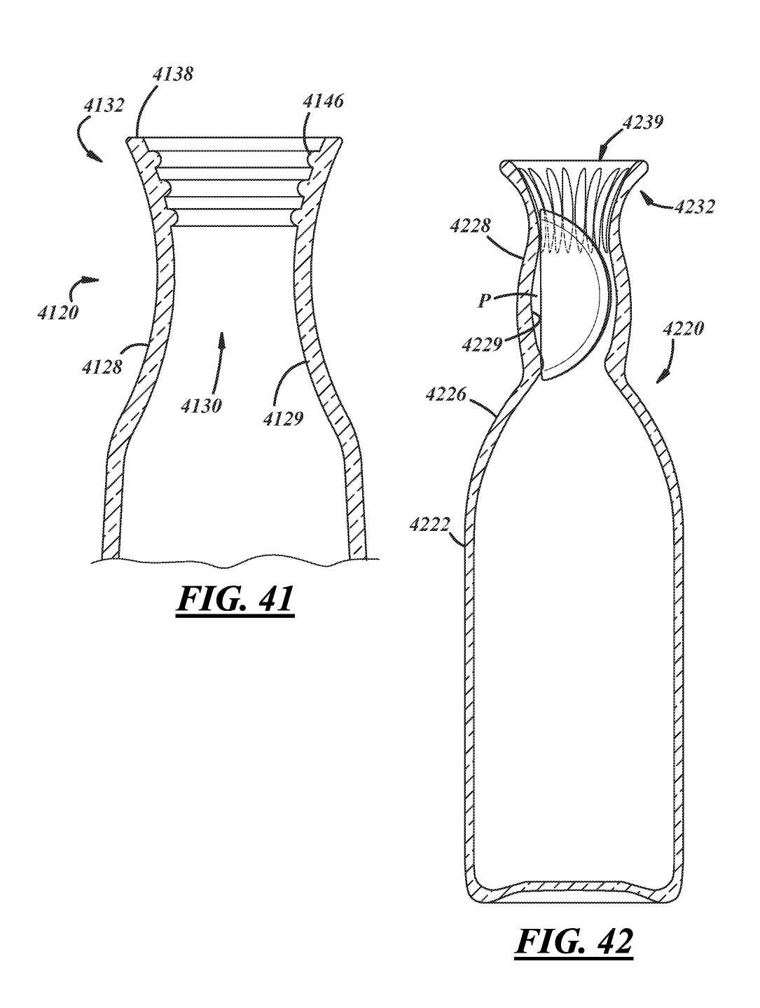

In another embodiment, in addition to or instead of the projections comprising either one or both of the axially-extending projections and an array of bumps or projections described above, the projections may comprise one or more circumferentially-extending projections formed in or onto an interior surface of the bottle, and the neck thereof, in particular, so as to project radially-inwardly into the neck interior. More particularly, and as illustrated in FIG. 41, the projections 4146 may comprise one or a plurality of circumferentially-extending projections formed in or onto the interior surface 4129 of the bottle neck 4128. Each of the one or more circumferentially-extending projections may comprise, for example, a ring extending along and about the entire circumference of the neck 4128. In another embodiment, however, each of the one or more projections 4146 may extend along only a portion of the circumference such that a complete ring is not formed. In yet another embodiment, some of the one or more projections 4146 may comprise a circumferentially-extending ring, while others may not. In an embodiment, at least one of the circumferentially-extending projections 4146 is disposed at or on a portion of the interior surface 4129 of the neck 4128 that corresponds to the neck finish 4132 such that at least one circumferentially-extending protrusion 4146 axially overlaps and is axially-aligned with at least a portion of the neck finish 4132. More specifically, at least one of the projections 4146 may be disposed adjacent the sealing surface 4138, or alternatively, may be disposed a location a predetermined axial distance below the sealing surface 4138 but still axially-aligned with at least a portion of the neck finish 4132 such that the projection 4146 axially overlaps at least a portion of the neck finish 4132.

In an embodiment wherein at least a portion of the neck finish 4132 has a conical or funnel shape, as it does in FIG. 41, at least one circumferentially-extending projection 4146 may be disposed at or on the conically-shaped portion of the neck finish 4132 such that at least one of the projections 4146 axially overlaps and is axially-aligned with at least a portion of the neck finish 4132. In an embodiment wherein the neck 4128 includes multiple circumferentially-extending projections 4146, the projections may be axially-spaced (uniformly or non-uniformly) along the axis of the bottle 4120 and/or circumferentially-spaced (uniformly or non-uniformly) along the interior surface 4129 of the neck 4128.

As with the projections described elsewhere above, each projection 4146 has a radially-innermost end portion that may be radiused or rounded, or alternatively, may be pointed or have a shape edge. Additionally, each of the projections 4146 may be substantially identical in shape and/or size. Alternatively, the projections 4146 may not be identical in size and/or shape. Regardless, as a piece of fruit is introduced into the bottle 4120 and moves through the neck finish 4132 and neck 4128, the projections 4146 serve to ream or abrade the fruit, thereby maximizing the amount of juice that is squeezed therefrom and guiding through the neck interior 4130.

In an instance wherein a bottle includes a neck having radially-inwardly extending projections in the form of either an array of bumps or one or more circumferentially-extending projections, any number of manufacturing processes may be utilized to form the bottle and the internal projections thereof. One example of such a process, though certainly not the only example, is the internal embossing process described in U.S. Patent Publication No. 2009/0084799 filed on Sep. 27, 2007, and U.S. Pat. No. 8,333,287 issued on Dec. 18, 2012, the entire contents of each of which are incorporated herein by reference.

In any event, and in view of the foregoing, it will be appreciated that the internal projections of the neck of a bottle may take any number of forms, including, but certainly not limited to, those described herein, and the bottles and projections thereof may be formed in any number of ways. Therefore, the present disclosure is not meant to be limited to any particular type or form of projections or method of manufacturing, but rather any suitable projections and/or manufacturing processes may be utilized.

In an embodiment, the bottle may additionally or alternatively include a pocket or trap formed in the neck and/or neck finish thereof that is configured and intended to hold therein a piece of fruit of a predetermined size that is introduced into the bottle as described elsewhere above.

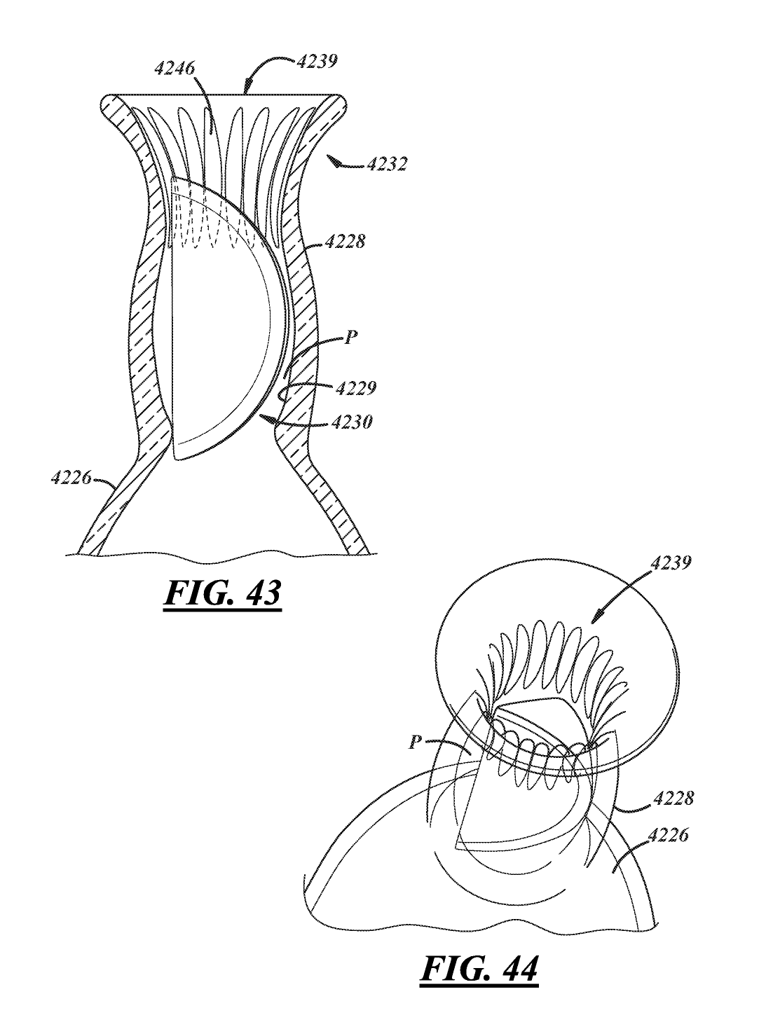

More particularly, and with reference to FIGS. 42-44, the bottle 4220, which may, but does not necessarily have to, comprise a wide-mouth bottle, may include a neck 4228, a neck finish 4232, and a shoulder 4226. The interior surface 4229 of at least a portion of the neck 4228 and/or neck finish 4232 may be contoured to form a pocket P in the neck interior 4230. The pocket P may include a top portion having a diameter suitable to allow a piece of fruit of a particular or predetermined size introduced into the bottle 4220 through the mouth 4239 to pass into the pocket P. The pocket P may further include a bottom portion axially spaced from the top portion (i.e., disposed axially beneath or below the top portion) and having a diameter suitable to capture the piece of fruit within the pocket P (i.e., the diameter of the bottom portion of the pocket P is sized to prevent the fruit from passing out of the pocket and further into the neck interior 4230 axially below the pocket P, and/or into the interior of the bottle body 4222 disposed axially below the neck 4228 and the pocket P). As shown in FIGS. 42-44, in an embodiment, the pocket P may have a bulbous shape, having a diameter that increases as the pocket P extends in an axial direction from the top portion of the pocket P to a point axially between the top and bottom portions of the pocket P, and then decreases as the pocket P extends from that point to the bottom portion of the pocket P. It will be appreciated, however, that the present disclosure is not limited to pocket P having any particular shape or geometry, but rather any suitable shape or geometry may be used.

In an embodiment, the bottle 4220 may include further one or more axially-extending projections 4246 formed in or on the interior surface 4229 of the neck 4228 as described elsewhere above. In such an embodiment, the projections 4246 may extend axially into the pocket P, or alternatively, may terminate at a point that is axially above the top portion of the pocket P. In any event, the inclusion of the pocket P allows for the piece of fruit introduced into the bottle 4220 to be held in the flow path of the product contained within the bottle 4220, thereby further enhancing, for example, the flavor of the product. In other words, when a piece of fruit is held in the pocket P and the product contained within the bottle is poured therefrom, the product flows over the piece of fruit which thereby enhances or influences every drink or pour from the bottle.

There thus has been disclosed a bottle that fully satisfies all of the objects and aims previously set forth. The disclosure has been presented in conjunction with several illustrative embodiments, and additional modifications and variations have been discussed. Other modifications and variations readily will suggest themselves to persons of ordinary skill in the art in view of the foregoing discussion. The disclosure is intended to embrace all such modifications and variations as fall within the spirit and broad scope of the appended claims.

1. A bottle comprising a neck that includes a longitudinal axis extending therethrough, said neck having:
a neck finish including an axially-facing sealing surface and a mouth adjacent thereto, at least a portion of said neck finish having an inside diameter that progressively narrows as the neck finish extends from said mouth in an axial direction away from said sealing surface such that at least a portion of said neck finish has a conical shape;
a radially-facing interior surface; and
one or more internal projections projecting in a radially-inwardly direction from said interior surface and axially overlapping at least a portion of said neck finish, wherein at least a portion of at least one of said one or more internal projections is disposed in said conically-shaped portion of said neck finish.

2. The bottle set forth in claim 1 wherein said at least one of said one or more projections and/or another one of said one or more projections terminates at a point that is a predetermined distance below said sealing surface and that is axially-aligned with at least a portion of said neck finish.

3. The bottle set forth in claim 2 wherein said predetermined distance comprises 0.25-0.50 inches.

4. The bottle set forth in claim 1 wherein said one or more projections comprises a plurality of projections.

5. The bottle set forth in claim 4 wherein said projections of said plurality of projections are uniformly spaced about the internal circumference of said neck.

6. The bottle set forth in claim 4 wherein said projections of said plurality of projections are non-uniformly spaced about the internal circumference of said neck.

7. The bottle set forth in claim 4 wherein at least a portion of said neck having said projections has at least one of an undulating circumferential profile, a clamshell-shaped profile, a cog or spline-shaped profile, a keyway-shaped profile, a sawtooth-shaped profile, a sun-shaped profile, a badge-shaped profile, and a lantern-shaped profile.

8. The bottle set forth in claim 1 wherein each of said one or more projections has a radially-innermost end, and further wherein said radially-innermost end of at least one of said one or more projections is radiused.

9. The bottle set forth in claim 1 wherein each of said one or more projections has a radially-innermost end, and said radially-innermost end of at least one of said one or more projections is pointed.

10. The bottle set forth in claim 1 wherein said neck further includes one or more internal grooves extending in a radially-outwardly direction and axially along, said interior surface and axially overlapping at least a portion of said neck finish, each of said one or more grooves being disposed adjacent to at least one of said one or more projections.

11. The bottle set forth in claim 1 wherein said at least one of said one or more projections and/or another one of said one or more projections extends axially along said interior surface of said neck.

12. The bottle set forth in claim 1 wherein said one or more projections comprises an array of bumps, at least a portion of the array axially overlapping at least a portion of said neck finish.

13. The bottle set forth in claim 1 wherein said one or more projections extends circumferentially along said interior surface of said neck.

14. The bottle set forth in claim 13, wherein said one or more circumferentially-extending projections comprises one or more circumferentially-extending rings.

15. The bottle set forth in claim 1, wherein at least a portion of said radially-facing interior surface is contoured to form a pocket in said neck, said pocket being configured to hold a piece of fruit therein and within the flow path of product contained within said bottle.

16. A bottle comprising a neck that includes a longitudinal axis extending therethrough, said neck having:
a neck finish including an axially-facing sealing surface and a mouth adjacent thereto, at least a portion of said neck finish having an inside diameter that progressively narrows as the neck finish extends from said mouth in an axial direction away from said sealing surface such that at least a portion of said neck finish has a conical shape;
a radially-facing interior surface;
a plurality of internal projections projecting in a radially-inwardly direction from said interior surface and axially overlapping at least a portion of said neck finish, wherein at least a portion of at least one of said one or more internal projections is disposed in said conically-shaped portion of said neck finish; and
a plurality of internal grooves extending in a radially-outwardly direction and axially along said interior surface and axially overlapping at least a portion of said neck finish, each of said plurality of grooves being disposed adjacent to at least one of said plurality of projections.

17. The bottle set forth in claim 16 wherein said at least one of said one or more projections and/or another one of said one or more projections terminates at a point that is a predetermined axial distance below said sealing surface and that is axially-aligned with at least a portion of said neck finish.

18. The bottle set forth in claim 17 wherein said predetermined axial distance comprises 0.25-0.50 inches.

19. The bottle set forth in claim 16 wherein at least a portion of said neck having said projections has at least one of an undulating circumferential profile, a clamshell-shaped profile, a cog or spline-shaped profile, a keyway-shaped profile, a sawtooth-shaped profile, a sun-shaped profile, a badge-shaped profile, and a lantern-shaped profile.

20. The bottle set forth in claim 16 wherein each of said one or more projections has a radially-innermost end, and further wherein said radially-innermost end of at least one of said one or more projections is radiused.

21. The bottle set forth in claim 16 wherein each of said one or more projections has a radially-innermost end, and said radially-innermost end of at least one of said one or more projections is pointed.

22. The bottle set forth in claim 16 wherein said at least one of said one or more projections and/or another one of said one or more projections extends axially along said interior surface of said neck.

23. The bottle set forth in claim 16 wherein said one or more projections comprises an array of bumps, at least a portion of the array axially overlapping at least a portion of said neck finish.

24. The bottle set forth in claim 16 wherein said one or more projections extends circumferentially along said interior surface of said neck.

25. The bottle set forth in claim 24, wherein said one or more circumferentially-extending projections comprises one or more circumferentially-extending rings.

26. The bottle set forth in claim 16, wherein at least a portion of said radially-facing interior surface is contoured to form a pocket in said neck, said pocket being configured to hold a piece of fruit therein and within the flow path of product contained within said bottle.
